(19) United States
(12) Patent Application Publication
(10) Pub. No.: US 2026/0113124 A1
(43) Pub. Date: Apr. 23, 2026

(54) SIGNAL PROCESSING CIRCUIT, OPTICAL RECEIVER, AND OPTICAL TRANSMISSION SYSTEM

(71) Applicant: Fujitsu Limited, Kawasaki-shi (JP)

(72) Inventors: Yasuo OHTOMO, Yokohama (JP); Masashi SATO, Kawasaki (JP); yoshitaka NOMURA, Shinagawa (JP)

(73) Assignee: Fujitsu Limited, Kawasaki-shi (JP)

(21) Appl. No.: 19/361,311

(22) Filed: Oct. 17, 2025

(30) Foreign Application Priority Data
Oct. 18, 2024 (JP) 2024-182342

(51) Int. Cl. H04B 10/61; H04L 25/03

(52) U.S. Cl. CPC H04B 10/6162; H04L 25/03057

(57) ABSTRACT

A signal processing circuit processes a received signal containing a training sequence (TS) and a pilot symbol, the signal processing circuit includes: a tap coefficient adaptive control processing unit that performs tap coefficient update processing using information regarding a plurality of symbols including the pilot symbol and thereby updates a plurality of tap coefficients; a finite impulse response (FIR) filter that performs adaptive equalization processing using the plurality of tap coefficients updated by the tap coefficient adaptive control processing unit; a TS synchronization detecting unit that performs TS synchronization detection using training sequence information of the received signal, based on output data of the FIR filter; and a pilot extraction processing unit that extracts a plurality of symbols including the pilot symbol contained in the received signal, based on TS synchronization information obtained from the TS synchronization detecting unit. The signal processing circuit performs initial startup of adaptive equalization in the FIR filter.

### CROSS REFERENCE TO RELATED APPLICATIONS

This application is based upon and claims the benefit of priority of the prior Japanese Patent Application No. 2024-182342, filed on Oct. 18, 2024, the entire contents of which are incorporated herein by reference.

### FIELD

The embodiments discussed herein are related to a signal processing circuit, an optical receiver, and an optical transmission system.

### BACKGROUND

Transmission path distortion, such as polarization fluctuations and polarization mode dispersion, that changes over time in optical communication transmission are adaptively compensated for by an adaptive equalizer (AEQ) installed in an optical transmission device. When the optical transmission device (AEQ) is initially started up, frame synchronization has to be performed to generate initial tap coefficients of the AEQ, even when the characteristics of the transmission path are unknown. For example, by a method using a specific known signal, the frame synchronization is performed using information in a training sequence (TS); then embedded pilot symbols (PS) are extracted periodically and adaptive equalization processing, such as polarization mode dispersion (PMD) compensation and polarization rotation compensation, is carried out since the PSs are a known signal.

Conventional techniques involve estimating the frequency offset and wavelength dispersion at an optical receiver based on the spectral shift of a known BPSK signal contained in a transmitted signal and thereby estimating signal timing. For example, refer to International Publication No. WO 2010/134321 and U.S. Patent Application Publication No. 20120070159.

### SUMMARY

According to an aspect of an embodiment, a signal processing circuit processes a received signal containing a training sequence (TS) and a pilot symbol, the signal processing circuit includes: a tap coefficient adaptive control processing unit that performs tap coefficient update processing using information regarding a plurality of symbols including the pilot symbol and thereby updates a plurality of tap coefficients; a finite impulse response (FIR) filter that performs adaptive equalization processing using the plurality of tap coefficients updated by the tap coefficient adaptive control processing unit; a TS synchronization detecting unit that performs TS synchronization detection using training sequence information of the received signal, based on output data of the FIR filter; and a pilot extraction processing unit that extracts a plurality of symbols including the pilot symbol contained in the received signal, based on TS synchronization information obtained from the TS synchronization detecting unit. The signal processing circuit performs initial startup of adaptive equalization in the FIR filter.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a signal processing circuit according to a first embodiment.

FIG. 2 is a diagram depicting a signal processing circuit according to a reference example.

FIG. 3 is a flowchart depicting an example of signal processing by the signal processing circuit of the reference example.

FIG. 4A is a diagram depicting an example of an existing transmission frame.

FIG. 4B is a diagram depicting an example of a new transmission frame.

FIG. 5 is a flowchart depicting an example of signal processing by the signal processing circuit of the first embodiment.

FIG. 6 is a diagram depicting a signal processing circuit according to a second embodiment.

FIG. 7A is an explanatory diagram of regeneration of tap coefficients due to equivalence convergence and cancellation of the equivalence convergence.

FIG. 7B is an explanatory diagram of the regeneration of tap coefficients due to the equivalence convergence and cancellation of the equivalence convergence.

FIG. 7C is an explanatory diagram of the regeneration of tap coefficients due to the equivalence convergence and cancellation of the equivalence convergence.

FIG. 7D is an explanatory diagram of the regeneration of tap coefficients due to the equivalence convergence and cancellation of the equivalence convergence.

FIG. 8 is a flowchart depicting an example of signal processing by a signal processing circuit of a second embodiment.

FIG. 9 is a diagram depicting functions of the signal processing circuit according to the second embodiment, during a steady state.

FIG. 10 is a flowchart depicting an example of signal processing by the signal processing circuit in the second embodiment, during the steady state.

FIG. 11 is a diagram depicting an example of a configuration of an optical receiver.

FIG. 12 is a diagram depicting an example of a configuration of an optical transmission system.

### DESCRIPTION OF EMBODIMENTS

First, problems associated with the conventional techniques rediscussed. In digital coherent optical transmission, the baud rate handled is set to a higher value to increase capacity and it is necessary to correspondingly increase the number of data symbols in a frame or reduce the number of TS symbols. For example, while the existing DP-16QAM has a TS symbol count of 192, the new Optical Internetworking Forum (OIF) 800ZR communication standard has a TS symbol count of 11, which is reduced. When the TS is used as a specific known signal as in the prior arts, the number of TS symbols, 11, is too short to accurately synchronize frames, making it difficult to capture PS.

Embodiments of a signal processing circuit, an optical receiver, and an optical transmission system disclosed herein are described in detail with reference to the drawings. The signal processing circuit according to an embodiment is applied to optical digital coherent optical transmission, has an AEQ, and adaptively compensates for transmission path distortions such as time-varying polarization fluctuations and polarization mode dispersion. Furthermore, in the embodiments, when the AEQ is started up in a state in which the characteristics of the transmission path are unknown, the initial startup of adaptive equalization processing by the AEQ may be performed even when the number of TS symbols in a frame is small.

In the present embodiment, for example, quadrature amplitude modulation (QAM) is used for optical communication transmission, and probabilistic constellation shaping (PCS) is used for the transmission signal. In PCS, the value of the bit string is converted to increase the frequency of use of inner symbol points close to the center of the constellation, thereby forming a mapping probability distribution. By increasing the frequency of use of inner symbol points with low power, it is possible to ensure a Euclidean distance as compared to conventional systems, with the same average power, thereby improving noise resistance and enabling efficient data transmission.

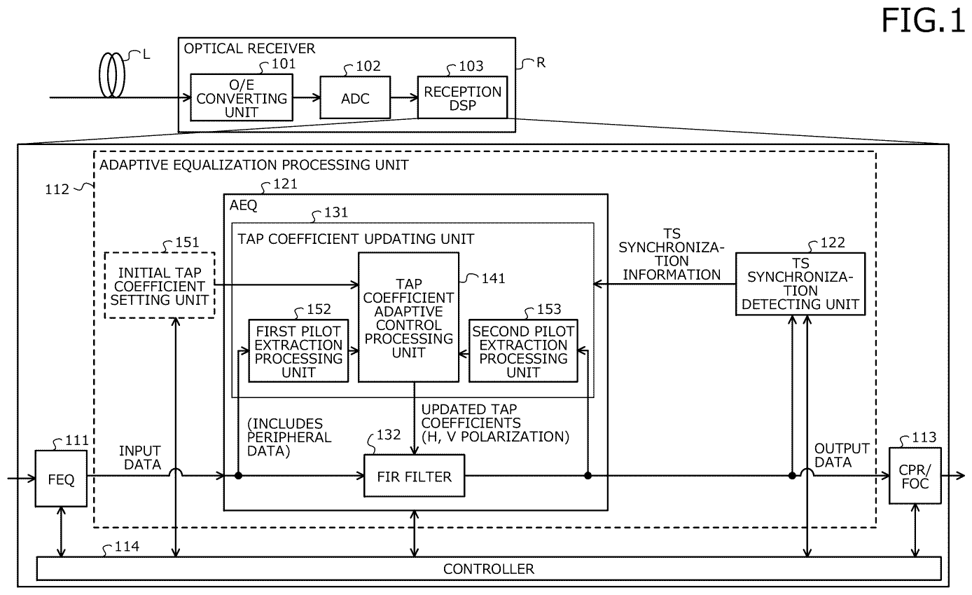

FIG. 1 is a diagram depicting a signal processing circuit according to a first embodiment. The signal processing circuit of the first embodiment corresponds to a reception digital signal processor (DSP) 103 depicted in FIG. 1. In the optical transmission system, a transmitting-side optical transmission device transmits an optical signal via an optical transmission line L, and a receiving-side optical transmission device (optical receiver) R receives the signal. The receiving-side optical transmission device R includes an O/E converting unit 101, an AD converter (ADC) 102, and the reception DSP 103. The O/E converting unit 101 opto-electrically converts the received optical signal and outputs the converted signal to the ADC 102. The ADC 102 performs analog-to-digital conversion on the electrical signal (received signal) after the opto-electric conversion and outputs the resulting signal to the reception DSP 103.

The reception DSP 103 performs data processing of the received signal and includes a fixed equalizer (FEQ) 111, an adaptive equalization processing unit 112, a CPR/FOC 113, and a controller 114. CPR stands for carrier phase recovery, and FOC stands for frequency offset compensation.

The FEQ 111 performs dispersion compensation, linear compensation, nonlinear compensation, etc. The adaptive equalization processing unit 112 performs compensation for the DGD (differential group delay) of two orthogonal polarization states, residual dispersion compensation, etc. The CPR/FOC 113 compensates for a discrepancy between the carrier frequency of the received optical signal and the frequency of the local oscillator light to restore the carrier phase. The controller 114 controls the FEQ 111, the adaptive equalization processing unit 112, and the CPR/FOC 113.

The adaptive equalization processing unit 112 includes an adaptive equalizer (AEQ) 121 and a TS synchronization detecting unit 122. The AEQ 121 includes a tap coefficient updating unit 131 and a finite impulse response (FIR) filter 132.

The TS synchronization detecting unit 122 performs frame synchronization based on training sequence (TS) information of the received signal, based on output data from the FIR filter 132, and outputs TS synchronization information to the tap coefficient updating unit 131 of the AEQ 121.

The tap coefficient updating unit 131 of the AEQ 121 includes a tap coefficient adaptive control processing unit 141. The tap coefficient adaptive control processing unit 141 performs tap coefficient adaptive control using a blind constant modulus algorithm (CMA). In the blind CMA, adaptive equalization processing is performed using CMA, a blind equalization, as an adaptive algorithm, from unknown signal symbols.

Here, in the first embodiment, the adaptive equalization processing unit 112 includes an initial tap coefficient setting unit 151, and the tap coefficient adaptive control processing unit 141 of the AEQ 121 performs tap coefficient adaptive control processing using blind CMA using only pilot symbols (PS). For this reason, the AEQ 121 has a first pilot extraction processing unit (152) and a second pilot extraction processing unit (153) before and after the tap coefficient adaptive control processing unit 141.

The first pilot extraction processing unit (152) extracts peripheral data including pilot symbols (PS) from the input data to the FIR filter 132 and outputs the extracted data to the tap coefficient adaptive control processing unit 141. The second pilot extraction processing unit (153) extracts pilot symbols (PS) from the output data of the FIR filter 132 and outputs the extracted pilot symbols to the tap coefficient adaptive control processing unit 141.

The AEQ 121 receives input data and output data of the FIR filter 132 via the tap coefficient adaptive control processing unit 141 of the tap coefficient updating unit 131, calculates updated tap coefficients that track fluctuations in the transmission path characteristics, and sets the updated tap coefficients in the FIR filter 132. The updated tap coefficients include tap coefficients for the orthogonal H and V polarizations.

The tap coefficient adaptive control processing unit 141 of the first embodiment performs tap coefficient adaptive control processing by blind CMA using only the pilot symbols (PS). The tap coefficient adaptive control processing unit 141 extracts pilots from the input/output data of the FIR filter 132 and passes the extracted pilot symbols (the input includes peripheral data of the pilots) to the tap coefficient adaptive control processing.

The signal processing circuit of the first embodiment performs the following signal processing during the initial startup of the adaptive equalization processing. The controller 114 controls the signal processing described below.
1. First frame synchronization processing is described. At the time of the initial startup, such as when the signal processing circuit (AEQ 121) is started, the TS synchronization detecting unit 122 performs TS synchronization detection at a stage before adaptive equalization processing is performed by the AEQ 121. In this state, the TS synchronization accuracy is coarse.

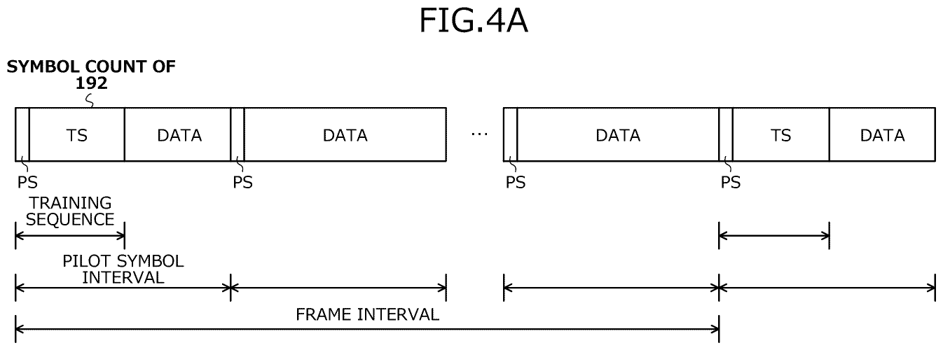

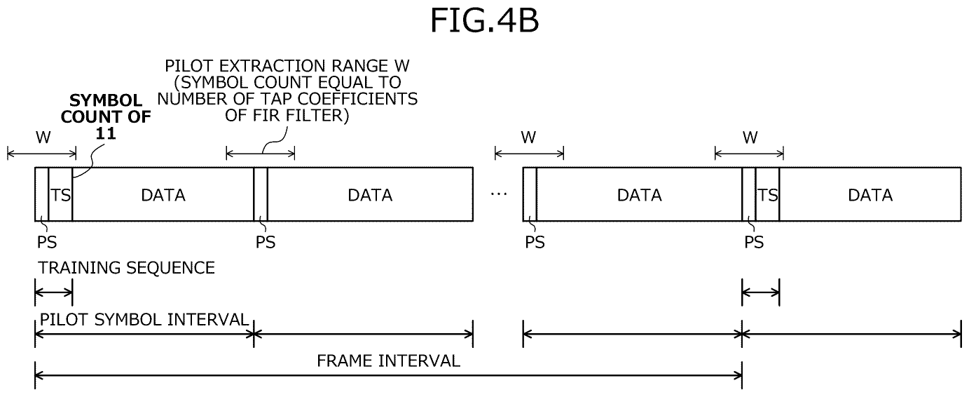

In the first embodiment, at the time of TS detection, the first and second pilot extraction processing units (152 and 153) extract multiple symbols around a PS symbol included in the frame of the received signal, as the pilot extraction range W (see FIG. 4B). The pilot extraction range W is set corresponding to the symbol count equal to the number of the tap coefficients of the FIR filter 132. For example, the number of symbols in the pilot extraction range W is an odd number of symbols including the tap center plus several symbols before and after the tap center, in other words, the tap center (1 symbol)+15 symbols before and after=31 symbols.
2. Next, the AEQ 121 sets the initial tap coefficients set by the initial tap coefficient setting unit 151, in the tap coefficient adaptive control processing unit 141.
3. Next, the tap coefficient adaptive control processing unit 141 obtains updated tap coefficients by blind CMA using only the PS based on the set initial tap coefficients, sets the updated tap coefficients in the FIR filter 132, and performs adaptive equalization processing such as PMD compensation and polarization rotation compensation.
4. Second frame synchronization processing is described. Next, the TS synchronization detecting unit 122 performs TS synchronization detection and determines TS synchronization information. 5. Next, the AEQ 121 corrects the tap coefficients based on the TS synchronization information, obtains updated tap coefficients after the correction, sets the updated tap coefficients in the FIR filter 132, and performs adaptive equalization processing such as PMD compensation and polarization rotation compensation. For example, when the AEQ 121 determines that synchronization has been achieved in the determination processing based on the TS synchronization information, the AEQ 121 performs tap coefficient update processing.

As described above, the initial startup process during the initial startup, such as starting up the signal processing circuit (AEQ 121), is completed in a state where the transmission characteristics of the optical transmission line L are unknown.

Next, problems associated with a reference example will be described.

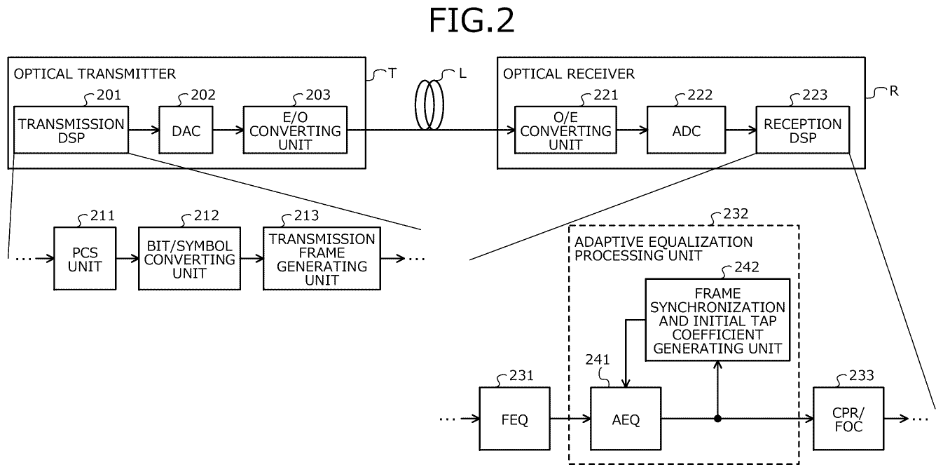

FIG. 2 is a diagram depicting a signal processing circuit according to the reference example. FIG. 2 depicts an example of the overall configuration of an optical transmission system that performs frame synchronization and adaptive equalization processing using TS and PS of a known signal. A transmitting-side optical transmission device (optical transmitter) T transmits an optical signal via the optical transmission line L, and a receiving-side optical transmission device (optical receiver) R receives the optical signal via the optical transmission line L.

The optical transmitter T has a transmission DSP 201, a DA converter (DAC) 202, and an E/O converting unit 203. The transmission DSP 201 has a PCS unit 211 that converts input data into PCS format, a bit/symbol converting unit 212 that maps the bits of the input PCS-converted data to symbols, and a transmission frame generation unit 213 that generates a transmission frame using the input data after the symbol conversion. The DAC 202 performs digital-to-analog conversion on the input data and outputs the result to the E/O converting unit 203. The E/O converting unit 203 converts the input data into an optical signal and sends the optical signal to the optical transmission line L.

The optical receiver R has an O/E converting unit 221, an ADC 222, and a reception DSP 223. The O/E converting unit 221 performs opto-electric conversion on the received optical signal and outputs the resulting signal to the ADC 222. The ADC 222 outputs the electrical signal (received signal) obtained by the opto-electric conversion to the receive DSP 223.

The receive DSP 223 performs data processing on the received signal and includes an FEQ 231, an adaptive equalization processing unit 232, and a CPR/FOC 233. The adaptive equalization processing unit 232 of the reference example includes an AEQ 241 and a frame synchronization and initial tap coefficient generating unit 242.

During the initial startup of the AEQ 241, the frame synchronization and initial tap coefficient generating unit 242 generates frame synchronization and initial tap coefficients for the AEQ 241.

When the AEQ 241 is initially started up, it is necessary to synchronize the frames and generate the initial tap coefficients of the AEQ 241. When a specific known signal is used according to the reference example, frame synchronization is performed based on TS information, and then the embedded PS is periodically extracted. Taking advantage of the fact that the PS is a known signal, adaptive equalization processing such as PMD compensation and polarization rotation compensation is performed.

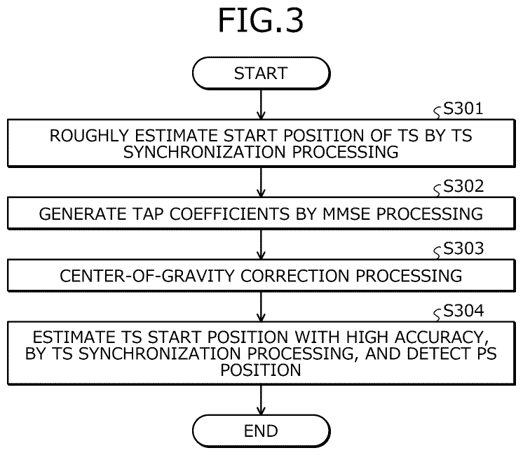

FIG. 3 is a flowchart depicting an example of signal processing by the signal processing circuit of the reference example. The following describes the initial startup processing of adaptive equalization performed by the adaptive equalization processing unit 232 of the signal processing circuit (optical receiver R) depicted in FIG. 2 during startup of the signal processing circuit (AEQ 241).

First, the start position of the TS is roughly estimated through TS synchronization processing (step S301). Next, minimum mean square error (MMSE) processing is performed using the TS signal included in the received frame to generate tap coefficients for the AEQ 241 (step S302).

Next, center-of-gravity correction processing is performed on the generated tap coefficients (step S303). Then, compensation processing is performed using the tap coefficients after the center-of-gravity correction processing, and the start position of the TS is estimated with high accuracy using TS synchronization processing, and the position of the PS is detected (step S304). This completes the frame synchronization and initial tap coefficient generation processing, and the initial startup processing of the signal processing circuit (AEQ 241) is completed.

FIG. 4A is a diagram depicting an example of an existing transmission frame. An optical transmission device on the transmitting side of an optical transmission system generates the transmission frame depicted in FIG. 4A. FIG. 4A depicts a transmission frame used in DP-16QAM. The optical transmission device on the transmitting side inserts a known TS and PSs at regular intervals into the input data symbols. Here, the number of TS symbols is 192.

FIG. 4B is a diagram depicting an example of a new transmission frame. FIG. 4B depicts an example of a transmission frame based on the new OIF 800ZR communication standard, and the number of TS symbols is 11 to increase the number of data symbols in the frame in response to an increase in bit rate. The number of TS symbols, 11, in FIG. 4B is significantly reduced compared to the number of TS symbols, 192, in FIG. 4A.

In the reference example, as depicted in FIG. 4A, when the number of TS symbols is large, frame synchronization may be performed using a known signal. However, as depicted in FIG. 4B, when the number of TS symbols is reduced, frame synchronization cannot be performed accurately, and PS cannot be captured.

Here, it is conceivable to use a blind CMA, which does not use a known signal.

However, when the blind CMA is used, in the transmission frame depicted in FIG. 4B, because PCS is applied to the signal symbols, the use of closely spaced symbol points near the center of the constellation is concentrated. In this case, the difference in intensity between the used symbols becomes so small that CMA calculations may not be possible.

Furthermore, when blind CMA is simply used when starting up the signal processing circuit (AEQ 241), the number of TS symbols (interval) is shortened in the transmission frame depicted in FIG. 4B, resulting in an error in TS synchronization detection and making it impossible to accurately detect PS symbols. In the reference example, when the extracted symbols do not include a PS symbol and only data symbols are extracted, CMA calculations are not possible due to the symbols being subject to PCS shaping.

The above processes 1 to 5 that address the above issues in the reference example are performed in the first embodiment. In the first embodiment, in TS detection, the first and second pilot extraction processing units (152 and 153) extract multiple symbols, including PS symbols, from the frame of the received signal. FIG. 4B depicts the pilot extraction range W to be extracted. Then, the tap coefficient adaptive control processing unit 141 of the AEQ 241 performs tap coefficient adaptive control processing using blind CMA using only PS. The CMA of the reference example differs from the first embodiment in that the CMA of the reference example performs tap coefficient adaptive control processing by referencing all data including TS and PS. The first and second pilot extraction processing units (152 and 153) extract PS from the input and output sides of the received signal to the FIR filter 132, thereby updating the tap coefficients in the tap coefficient adaptive control processing unit 141.

The pilot extraction range W has a predetermined range, and the PS is included in the extracted few symbols, making it possible to perform CMA calculations based on the PS. Thus, the first embodiment enables the initial startup of adaptive equalization processing even when the number of TS symbols included in the received frame is reduced.

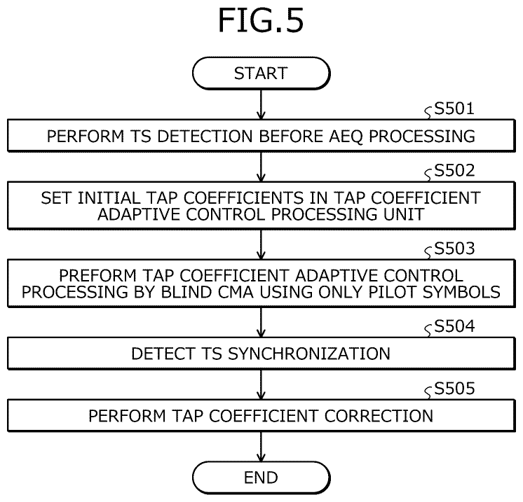

A signal processing example of the first embodiment is described. FIG. 5 is a flowchart depicting an example of signal processing by the signal processing circuit of the first embodiment. The initial startup processing of adaptive equalization at the startup of the signal processing circuit (optical receiver R) depicted in FIG. 1 is described below. The following processing is controlled by the controller 114. In the first embodiment, tap coefficients are updated when TS and PS are known signals.

At the time of the initial startup, TS detection is performed by the TS synchronization detecting unit 122 before adaptive equalization processing by the AEQ 121 (step S501). At this time, multiple symbols including pilot symbols are extracted within the pilot extraction range W. The TS synchronization detection accuracy at step S501 is coarse. Next, initial tap coefficients are set in the tap coefficient adaptive control processing unit 141 (step S502).

After setting the initial tap coefficients, the tap coefficient adaptive control processing unit 141 performs tap coefficient adaptive control processing by blind CMA using only the PS (step S503). At this time, the tap coefficient adaptive control processing unit 141 uses the PS included in the pilot extraction range W. As a result, updated tap coefficients are set into the FIR filter 132.

Thereafter, TS synchronization detection is carried out by the TS synchronization detecting unit 122, and TS synchronization information is determined (step S504). Thereafter, the tap coefficient adaptive control processing unit 141 performs tap coefficient correction based on the TS synchronization information (step S505). The TS synchronization detection achieves accurate TS synchronization, and the tap coefficients are corrected to adapt to the transmission path characteristics. Thus, the initial startup at the startup of the signal processing circuit (AEQ 121) is completed, and the signal processing circuit transitions to steady-state processing during operation.

In the steady-state processing, the controller 114 stops the TS synchronization detection performed by the TS synchronization detecting unit 122. Furthermore, the controller 114 switches the tap coefficient updating unit 131 to tap coefficient adaptive control processing by least mean square (LMS) using only the PS.

According to the first embodiment, TS detection is performed before AEQ equalization, and rough TS detection is performed. At this time, multiple symbols including pilot symbols are extracted within the pilot extraction range W. Then, after the initial tap coefficients are set, tap coefficient update processing is performed by blind CMA using only the PS, enabling accurate TS synchronization detection and the determination of tap coefficients corresponding to the transmission path characteristics. This makes it possible to perform the initial startup of the adaptive equalization processing at the startup of the signal processing circuit, even when the number of TS symbols in a frame is reduced.

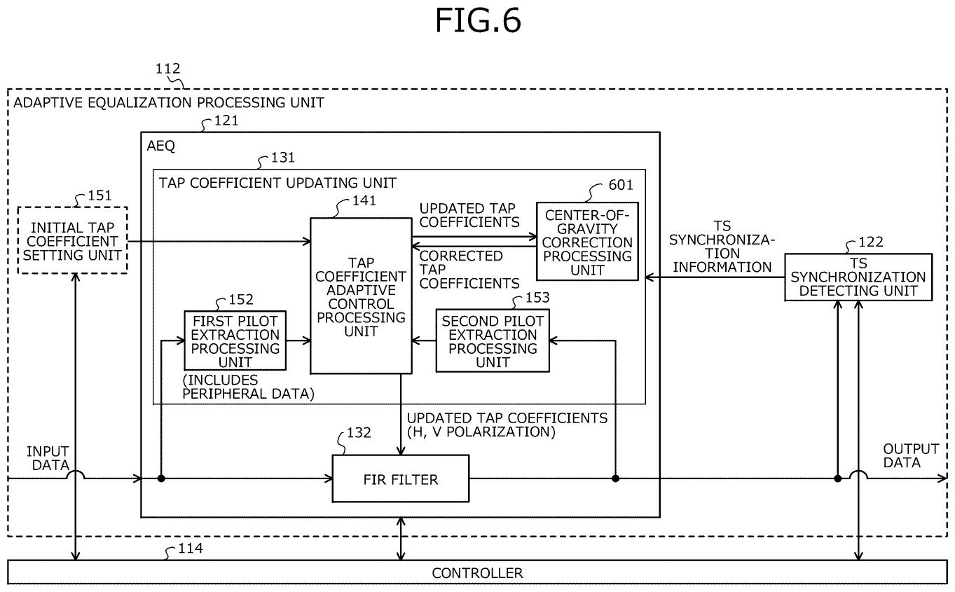

FIG. 6 is a diagram depicting a signal processing circuit according to a second embodiment. FIG. 6 depicts another example of the configuration of the signal processing circuit (adaptive equalization processing unit 112 in the reception DSP 103) of the first embodiment described in FIG. 1, and the same components as in FIG. 1 are assigned the same reference numerals used in FIG. 1. In the second embodiment, the problem that occurs when equivalence convergence occurs in TS synchronization detection (corresponding to step S504 in FIG. 5) is resolved. Furthermore, a function is added to correct deviation (from the tap center) of the center of gravity of the updated tap coefficients for each of the orthogonal polarizations (H and V).

The configuration depicted in FIG. 6 differs from that of FIG. 1 in that a center-of-gravity correction processing unit 601 is disposed in the tap coefficient updating unit 131. The updated tap coefficients calculated by the tap coefficient adaptive control processing unit 141 are input to the center-of-gravity correction processing unit 601. The center-of-gravity correction processing unit 601 corrects center deviation (from the tap center) of the center of gravity of each of the orthogonal polarizations (H, V) of the updated tap coefficients. The center-of-gravity correction processing unit 601 then outputs the corrected tap coefficients to the tap coefficient adaptive control processing unit 141.

When equivalence convergence occurs in the TS synchronization detection, the blind CMA using only the PS will not obtain a correct output from the FIR filter 132, and the TS synchronization detecting unit 122 will not function correctly. When the equivalence convergence occurs, the equivalence convergence will not be released unless polarization rotation or the like occurs in the input data to the AEQ 121, causing a change in the polarization state and the initial startup cannot be completed.

In the second embodiment, the controller 114 determines whether the equivalence convergence occurs in the TS synchronization detection by the TS synchronization detecting unit 122. When equivalence convergence is determined, the controller 114 stops the tap coefficient update by the tap coefficient adaptive control processing unit 141. Furthermore, the controller 114 completes the TS synchronization detection process by feeding back TS synchronization information (synchronous/asynchronous information, symbol deviation information when asynchronous, etc.) as information for the next TS synchronization detection.

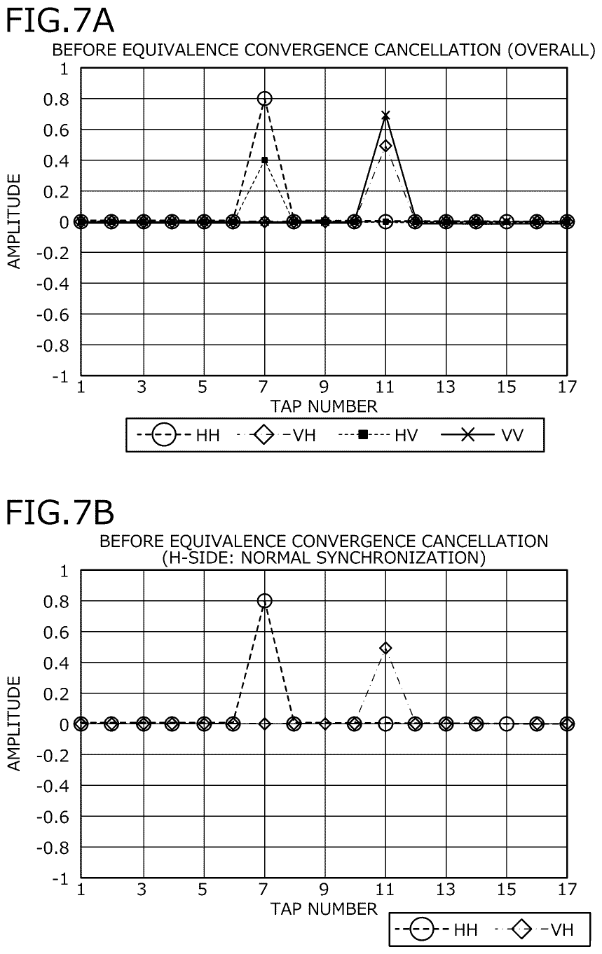

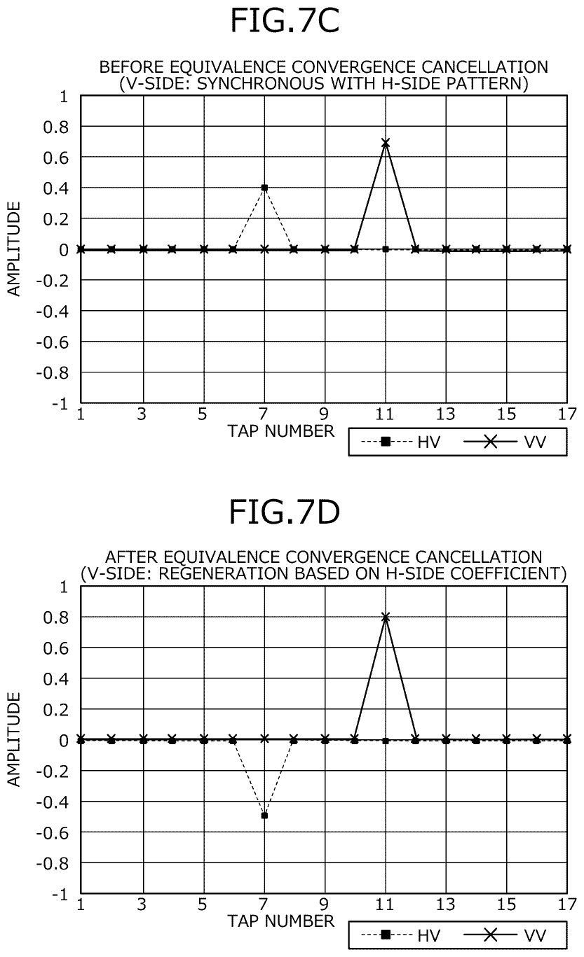

FIGS. 7A, 7B, 7C, and 7D are explanatory diagrams of the regeneration of tap coefficients due to the equivalence convergence and cancellation of the equivalence convergence. In FIGS. 7A to 7D, the horizontal axes represent the tap numbers of the FIR filter 132, and the vertical axes represent the amplitudes of each polarization (tap coefficients for X-axis polarization: HH and VH, tap coefficients for Y-axis polarization: HV and VV).

The equivalence convergence refers to a state in which multiple polarizations converge to the same information source in a polarization-multiplexed coherent optical receiver. In the example depicted in FIG. 7A, HH and HV are the same tap number 7, and VH and VV are the same tap number 11 (before cancellation of the equivalence convergence). FIG. 7B depicts only the H-side (H-branch) coefficients (HH and VH) of FIG. 7A, and FIG. 7C depicts only the V-side (V-branch) coefficients (HV and VV) of FIG. 7A.

To prevent equivalence convergence, the tap coefficients of one polarization are regenerated based on the tap coefficient output of the other polarization (equivalence convergence cancellation). For example, when generating V-side coefficients from the H-side coefficients depicted in FIG. 7B, the H-side coefficients are folded at (reflected about) the tap center (tap number 9, the center tap midway between tap numbers 7 and 11), and a complex conjugate transform is applied to the folded coefficients to obtain the V-side coefficients (FIG. 7D, after the equivalence convergence cancellation). In this case, FIG. 7B is used for the H-side coefficients, and FIG. 7D is used for the V-side coefficients (FIG. 7C is not used as the V-side coefficients).

Furthermore, when determining the equivalence convergence, the controller 114 stops the tap coefficient update by the tap coefficient adaptive control processing unit 141. As for the need to stop the tap coefficient update, when the TS synchronization information is determined to have equivalence convergence, it is necessary to stop the tap coefficient update and perform TS synchronization detection for the following reasons.

For example, an instance is assumed in which the equivalence convergence occurs at the time of blind CMA using only PS, and the output data on the H side and V side are both H side. In this case, the position of the received pilot on the H side is detectable. To cancel the equivalence convergence, the V side coefficients are calculated from the H side tap coefficients. Although it is desirable to perform coefficient update using the regenerated V-side tap coefficients, the expected pilot positions on the V side are unknown and therefore, the coefficient update will not proceed smoothly. Thus, in another embodiment, after canceling the equivalence convergence, the controller 114 performs TS synchronization detection without updating the tap coefficients, and resumes tap coefficient update after calculating accurate pilot positions on the H and V sides.

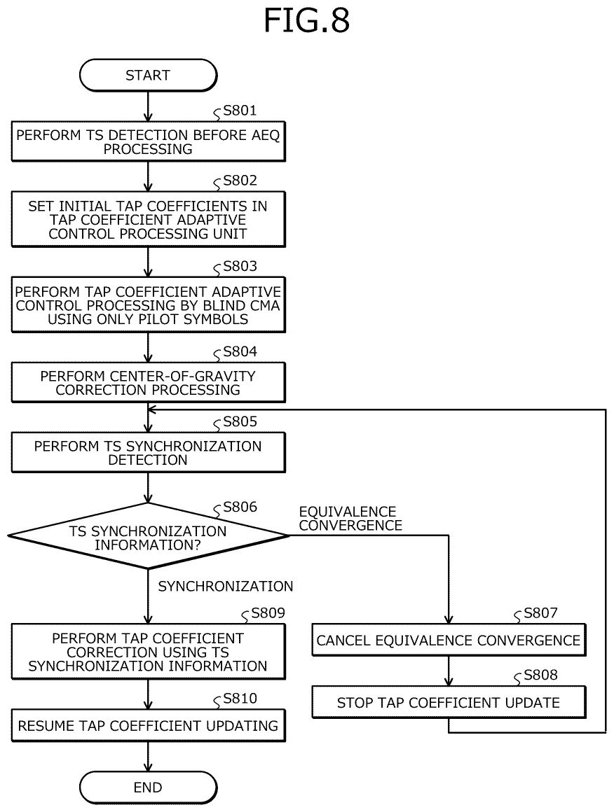

A signal processing example of a second embodiment is described. FIG. 8 is a flowchart depicting an example of signal processing by a signal processing circuit of a second embodiment. The initial startup process for adaptive equalization at the startup of the signal processing circuit (optical receiver R) depicted in FIG. 6 is described. The following process is controlled by the controller 114.

At the time of the initial startup, the TS detection is performed by the TS synchronization detecting unit 122 before adaptive equalization processing by the AEQ 121 (step S801). At this time, multiple symbols including pilot symbols are extracted within the pilot extraction range W. The TS synchronization detection accuracy at step S801 is low. Next, the initial tap coefficients are set in the tap coefficient adaptive control processing unit 141 (step S802).

After setting the initial tap coefficients, the tap coefficient adaptive control processing unit 141 performs tap coefficient adaptive control processing by blind CMA using only the PS (step S803). At this time, the tap coefficient adaptive control processing unit 141 uses the PS included in the pilot extraction range W. As a result, updated tap coefficients are set in the FIR filter 132.

Furthermore, the center-of-gravity correction processing unit 601 performs center-of-gravity correction processing (step S804). The center-of-gravity correction processing unit 601 corrects the tap center shift for the updated tap coefficients calculated by the tap coefficient adaptive control processing unit 141, and outputs the corrected tap coefficients to the tap coefficient adaptive control processing unit 141.

Thereafter, the TS synchronization detecting unit 122 performs TS synchronization detection (step S805), and judges TS synchronization information (step S806). When the judgment result at step S806 is “equivalence convergence,” the process proceeds to step S807. When the judgment result is “TS synchronization,” the process proceeds to step S809.

At step S807, the controller 114 performs processing to cancel the equivalence convergence (see FIGS. 7A to 7D) (step S807). The controller 114 then stops tap coefficient update (step S808) and returns to processing at step S805. By returning to processing at step S805, the equivalence convergence cancellation and tap coefficient update may be resumed based on subsequently received input data that changes over time.

At step S809, the tap coefficient adaptive control processing unit 141 receives symbol deviation information indicated by the TS synchronization information from the TS synchronization detecting unit 122 and performs tap coefficient correction to suppress symbol differences between polarizations, based on the deviation information (step S809). The TS synchronization detection achieves accurate TS synchronization, and the tap coefficients are corrected to adapt to the transmission path characteristics. The tap coefficient adaptive control processing unit 141 determines updated tap coefficients to be set in the FIR filter 132, based on the corrected tap coefficients. When the tap coefficient update has been stopped due to the equivalence convergence, the tap coefficient update is resumed (step S810). This completes the initial startup at startup of the signal processing circuit (AEQ 121), and the signal processing circuit transitions to steady-state processing during operation.

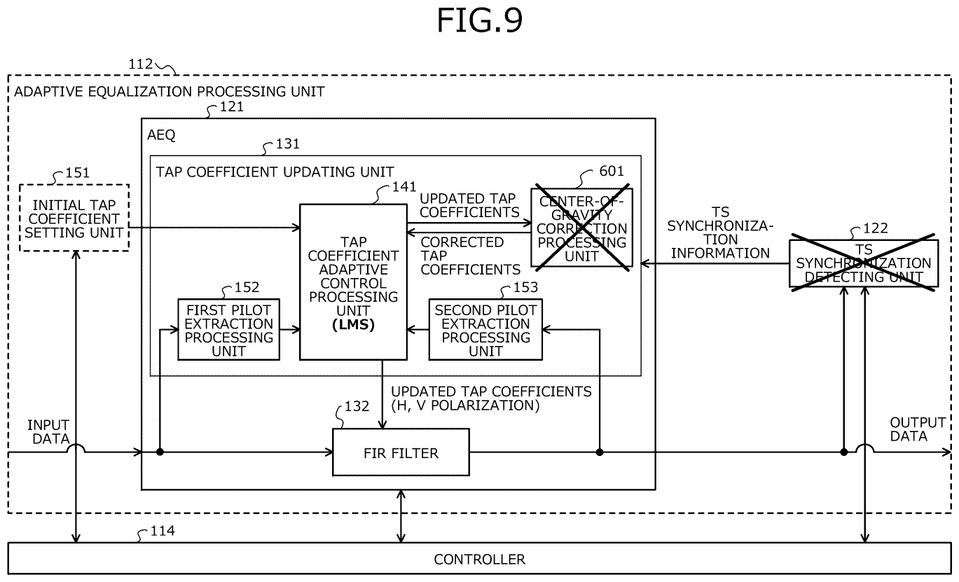

An example of functions during the steady state. FIG. 9 is a diagram depicting functions of the signal processing circuit according to the second embodiment, during the steady state. Functions after the completion of the initial startup processing at startup described with reference to FIG. 6are depicted. As depicted in FIG. 9, during the steady state, the controller 114 disables the functions of the TS synchronization detecting unit 122 and the center-of-gravity correction processing unit 601. Furthermore, the controller 114 switches the tap coefficient adaptive control processing unit 141 to tap coefficient adaptive control processing by LMS using only PS.

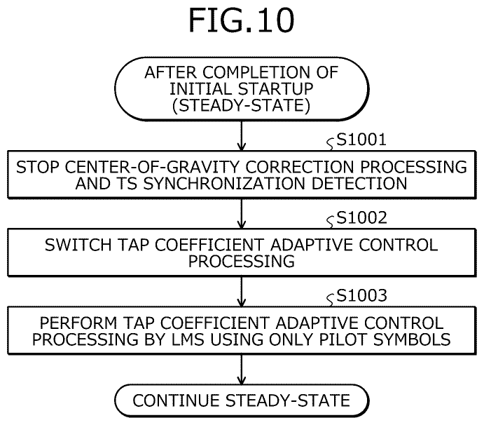

FIG. 10 is a flowchart depicting an example of signal processing by the signal processing circuit in the second embodiment, during the steady state. After completing the processing depicted in FIG. 8 (after initial startup is complete), the controller 114 performs the steady-state processing depicted in FIG. 10.

First, the controller 114 stops the center-of-gravity correction processing by the center-of-gravity correction processing unit 601 and the TS synchronization detection by the TS synchronization detecting unit 122 (step S1001). Next, the controller 114 switches the tap coefficient adaptive control processing unit 141 (step S1002). At this time, the controller 114 causes the tap coefficient adaptive control processing unit 141 to perform tap coefficient adaptive control processing by LMS using only the PS (step S1003). As described above, the steady-state processing depicted in FIG. 10 is performed during operation.

According to the second embodiment, the TS detection is performed before AEQ equalization, and rough TS detection is performed. At this time, multiple symbols including pilot symbols are extracted within the pilot extraction range W. After the initial tap coefficients are set, tap coefficient update processing is performed by blind CMA using only the PS, enabling accurate TS synchronization detection and determination of tap coefficients corresponding to the transmission path characteristics. In addition, in the second embodiment, the initial startup of adaptive equalization processing may be completed by correcting the center of gravity shift of the tap coefficients and controlling the suspension of tap coefficient update based on the determination of whether the equivalence convergence has occurred. Thus, it is possible to perform the initial startup of adaptive equalization processing at the startup of the signal processing circuit, even when the number of TS symbols in a frame is reduced.

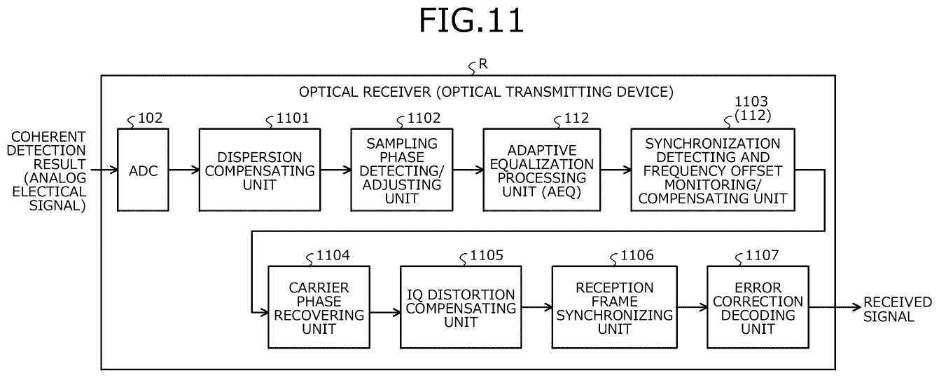

FIG. 11 is a diagram depicting an example of a configuration of an optical receiver. The signal processing circuit described above may be applied to the optical receiver R disposed on the receiving side of the optical transmission device depicted in FIG. 11. In FIG. 11, the same functions as those depicted in FIG. 1 are assigned the same reference numerals used in FIG. 1. The signal processing circuit depicted in FIG. 1 corresponds to a function of the adaptive equalization processing unit (AEQ) 112 depicted in FIG. 11.

As depicted in FIG. 11, in the optical receiver R, the ADC 102 receives the coherent detection result of the received signal (analog electrical signal), converts the signal to a digital signal, and outputs the digital signal. A dispersion compensating unit 1101 compensates for waveform distortion caused by dispersion such as polarization mode dispersion (PMD). A sampling phase detecting/adjusting unit 1102 adjusts the phase position when sampling digital data and outputs the result to the adaptive equalization processing unit 112. The adaptive equalization processing unit 112 performs the adaptive equalization processing using the above-mentioned CMA.

A synchronization detecting and frequency offset monitoring/compensating unit 1103 includes functions of the TS synchronization detecting unit 122 and FOC, and detects and compensates for the difference (frequency offset) between the carrier frequency of the received signal and the frequency of the local oscillator light. A carrier phase recovering unit 1104 includes the above-mentioned CPR function and recovers the phase of the carrier wave. For example, the amount of frequency offset may be detected using a well-known method, and the frequency offset is compensated for by reverse-rotating the constellation at a phase rotation speed corresponding to the detected frequency error.

An IQ distortion compensating unit 1105 compensates for IQ distortion (IQ imbalance, IQ imperfection, etc.) occurring within the optical receiver R. A reception frame synchronizing unit 1106 performs frame synchronization of the receive signal. An error correction decoding unit 1107 corrects bit errors using an error correction code generated by an FEC (forward error correction code) decoder, decodes the received signal, and outputs it.

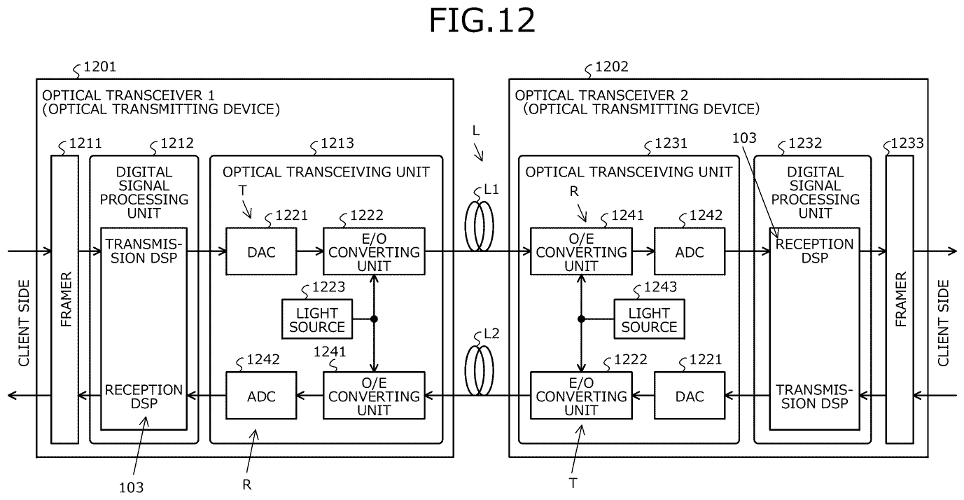

FIG. 12 is a diagram depicting an example of a configuration of an optical transmission system. The signal processing circuits described in the above-mentioned first and second embodiments have been described using an optical receiver disposed on the receiving side of an optical transmission device as an example. As depicted in FIG. 12, optical transceivers 1 and 2 (1201 and 1202) are disposed as optical transmission devices at both ends of an optical transmission path L, respectively.

In the optical transceiver 1 (1201), the transmitting side T sends an optical signal via downstream optical transmission path L1, and the receiving side R of the optical transceiver 2 (1202) receives the optical signal. On the other hand, the transmitting side T of the optical transceiver 2 (1202) sends out an optical signal via the upstream optical transmission line L2, and the receiving side R of the optical transceiver 1 (1201) receives the optical signal.

The components of the transmitting side T of the optical transceiver 1 (1201) are as follows: a framer 1211 frames the input signal from the client on the optical transceiver 1 (1201) side, and the transmission DSP of a digital signal processing unit 1212, which is configured a DSP, performs data processing on the transmission signal. In an optical transceiving unit 1213, a DAC 1221 performs digital-to-analog conversion of the transmission signal, an E/O converting unit 1222 converts the electrical signal to an optical signal and sends the optical signal to the optical transmission line L1. A light source 1223 is a local light source that generates the optical signal to be transmitted, and the optical signal is transmitted after undergoing predetermined optical modulation.

The components of the receiving side R of the optical transceiver 2 (1202) are as follows: an O/E converting unit 1241 of an optical transceiving unit 1231 converts the optical signal to an electrical signal, and an ADC 1242 performs analog-to-digital conversion of the received signal. A light source 1243 is a local light source that demodulates the received optical signal. The reception DSP of a digital signal processing unit 1232, which is configured by a DSP, performs reception processing. This reception DSP corresponds to the reception DSP 103 depicted in FIG. 1 described above and includes functions of the adaptive equalization processing unit 112. The output of the reception DSP is framed via a framer 1233 and output as an output signal to the client on the optical transceiver 2 (1202) side.

The components of the reception side R of the optical transceiver 1 (1201) are the same as the components of the reception side R of the optical transceiver 2 (1202). Furthermore, the components of the transmission side T of the optical transceiver 2 (1202) are the same as the components of the transmission side T of the optical transceiver 1 (1201). In FIG. 12, identical components are denoted by the same reference numerals.

As depicted in FIG. 12, each optical transmission device (optical transceiver) disposed at each end of the optical transmission path L has functions of an optical transmitter T and an optical receiver R. The optical receiver R may be implemented by the adaptive equalization processing unit (AEQ) 112 described in the above embodiment.

Currently, the adaptive equalization processing unit 112 uses a dedicated DSP because high-speed signal processing is necessary. However, the adaptive equalization processing unit 112 may also be configured using an ASIC or FPGA that supports high-speed processing. Furthermore, a high-speed CPU may be used as the controller 114 of the adaptive equalization processing unit 112 in the future. ASIC is the abbreviation for application specific integrated circuit, and FPGA is the abbreviation for field programmable gate array.

The signal processing circuit of the embodiment described above processes a received signal including a training sequence and pilot symbols, and includes the tap coefficient adaptive control processing unit that updates tap coefficients using information regarding multiple symbols including the pilot symbols; the FIR filter that performs adaptive equalization using the updated tap coefficients determined by the tap coefficient adaptive control processing unit; the TS synchronization detecting unit that performs TS synchronization detection from information regarding the training sequence of the received signal, based on output data from the FIR filter; and pilot extraction processing units that extract multiple symbols including pilot symbols from the received signal, based on TS synchronization information obtained from the TS synchronization detecting unit, thereby performing the initial startup for adaptive equalization in the FIR filter. As described, rough TS synchronization is performed before the equalization control process, and multiple symbols including pilot symbols are extracted within the pilot extraction range W. By updating the first update tap coefficients using only the PS, it becomes possible to determine the updated tap coefficients even when receiving frames with a small number of TS symbols due to a high bit rate at the time of the initial startup of the equalization control process when the transmission path characteristics are unknown.

In the signal processing circuit of the embodiment, after the tap coefficient update processing, the TS synchronization detecting unit performs TS synchronization detection based on the training sequence of the received signal, and the tap coefficient adaptive control processing unit corrects the update tap coefficients when the TS synchronization detecting unit detects TS synchronization. This allows for accurate TS synchronization even when the number of TS symbols in a frame is small, and allows for the determination of tap coefficients corresponding to the transmission path characteristics, thereby completing the initial startup of the equalization control process.

The signal processing circuit of the embodiment further includes a center-of-gravity correction processing unit that corrects the center offset of the updated tap coefficients updated by the tap coefficient adaptive control processing unit with respect to the tap center. This allows for the center offset of the first update tap coefficients to be corrected, thereby enabling the initial startup of the equalization control process to be completed with greater accuracy.

In the signal processing circuit of the embodiment, the tap coefficient adaptive control processing unit stops the updating of the tap coefficients when the TS synchronization detecting unit detects the equivalence convergence. This enables tap coefficient adaptive control using only PS to achieve the equivalence convergence, thereby enabling accurate tap coefficients to be obtained.

In the signal processing circuit of the embodiment, at the time of steady state after the initial startup, the TS synchronization detecting unit stops processing, and the tap coefficient adaptive control processing unit switches to tap coefficient adaptive control processing by LMS using only pilot symbols. This enables a smooth transition to steady state processing after the initial startup of the equalization control processing is complete.

In the signal processing circuit of the embodiment, the tap coefficient adaptive control processing unit updates the tap coefficients based on blind CMA using only pilot symbols extracted by the pilot extraction processing units. This enables adaptive equalization processing to be performed using unknown signal symbols and enables the initial startup of adaptive equalization processing even when the number of TS symbols included in the received signal is small due to a high rate.

The optical receiver of the embodiment includes the O/E converter that converts the received optical signal into an electrical signal, the ADC that performs analog-to-digital conversion of the received signal converted by the O/E converter, and the above signal processing circuit that receives and processes the received signal including the training sequence and pilot symbols output by the ADC. As described, the signal processing circuit is applicable to an optical receiver that receives an optical reception signal.

Also, an optical transmission system according to an embodiment includes the optical transmitter that transmits an optical signal including a training sequence and a pilot symbol, and the optical receiver that receives the optical signal including the training sequence and the pilot symbol, and the optical receiver has the above signal processing circuit that receives and processes the reception signal including the training sequence and pilot symbols. As described, the signal processing circuit is applicable to an optical transmission system that transmits and receives an optical reception signal.

According to one aspect of the present disclosure, an effect may be achieved in that initial startup of adaptive equalization processing is enabled even with a reduced number of TS symbols within a frame.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A signal processing circuit that processes a received signal containing a training sequence (TS) and a pilot symbol, the signal processing circuit comprising:
a tap coefficient adaptive control processing unit that performs tap coefficient update processing using information regarding a plurality of symbols including the pilot symbol and thereby updates a plurality of tap coefficients;
a finite impulse response (FIR) filter that performs adaptive equalization processing using the plurality of tap coefficients updated by the tap coefficient adaptive control processing unit;
a TS synchronization detecting unit that performs TS synchronization detection using training sequence information of the received signal, based on output data of the FIR filter; and
a pilot extraction processing unit that extracts a plurality of symbols including the pilot symbol contained in the received signal, based on TS synchronization information obtained from the TS synchronization detecting unit, wherein
the signal processing circuit performs initial startup of adaptive equalization in the FIR filter.

2. The signal processing circuit according to claim 1, wherein after the tap coefficient update processing,
the TS synchronization detecting unit performs TS synchronization detection based on the training sequence of the received signal, and
the tap coefficient adaptive control processing unit corrects the updated plurality of tap coefficients when the TS synchronization detecting unit detects TS synchronization.

3. The signal processing circuit according to claim 1, further comprising:
a center-of-gravity correction processing unit that corrects a deviation of the plurality of tap coefficients updated by the tap coefficient adaptive control processing unit, the deviation being from a tap center of the plurality of tap coefficients.

4. The signal processing circuit according to claim 2, wherein
the tap coefficient adaptive control processing unit stops the tap coefficient update processing when the TS synchronization detecting unit detects equivalence convergence.

5. The signal processing circuit according to claim 2, wherein during a steady state after the initial startup,
the TS synchronization detecting unit stops processing, and
the tap coefficient adaptive control processing unit switches the tap coefficient update processing to tap coefficient adaptive control processing by least mean square (LMS) using only the pilot symbol.

6. The signal processing circuit according to claim 1, wherein
the tap coefficient adaptive control processing unit updates the plurality of tap coefficients, based on a blind constant modulus algorithm (CMA) using only the pilot symbol extracted by the pilot extraction processing unit.

7. An optical receiver comprising:
an O/E converter that converts a received signal from an optical signal into an electrical signal;
an ADC that performs analog-to-digital conversion of the received signal after conversion by the O/E converter; and
a signal processing circuit that receives and processes the received signal output by the ADC, the received signal containing a training sequence and a pilot symbol,
the signal processing circuit having:
a tap coefficient adaptive control processing unit that performs tap coefficient update processing using information regarding a plurality of symbols including the pilot symbol and thereby updates the plurality of tap coefficients;
a finite impulse response (FIR) filter that performs adaptive equalization processing using the plurality of tap coefficients updated by the tap coefficient adaptive control processing unit;
a training sequence (TS) synchronization detecting unit that performs TS synchronization detection using training sequence information of the received signal, based on output data of the FIR filter; and
a pilot extraction processing unit that extracts a plurality of symbols including the pilot symbol contained in the received signal, based on TS synchronization information obtained from the TS synchronization detecting unit, wherein
the signal processing circuit performs initial startup of adaptive equalization in the FIR filter.

8. An optical transmission system comprising:
an optical transmitter that transmits an optical signal containing a training sequence and a pilot symbol; and
an optical receiver that receives the optical signal containing the training sequence and the pilot symbol, the optical receiver having a signal processing circuit that receives and processes the received signal containing the training sequence and the pilot symbol,
the signal processing circuit having:
a tap coefficient adaptive control processing unit that performs tap coefficient update processing using information regarding a plurality of symbols including the pilot symbol and thereby updates a plurality of tap coefficients;
a finite impulse response (FIR) filter that performs adaptive equalization processing using the plurality of tap coefficients updated by the tap coefficient adaptive control processing unit;
a TS synchronization detecting unit that performs TS synchronization detection using training sequence information of the received signal, based on output data of the FIR filter; and
a pilot extraction processing unit that extracts a plurality of symbols including the pilot symbol contained in the received signal, based on TS synchronization information obtained from the TS synchronization detecting unit, wherein
the signal processing circuit performs initial startup of adaptive equalization in the FIR filter.

9. The optical transmission system according to claim 8, wherein
the optical transmitter further transmits an optical signal subjected to PCS processing.
